(19) United States
(12) Patent Application Publication
(10) Pub. No.: US 2005/0109559 A1
(43) Pub. Date: May 26, 2005

(54) Climbing hold

(75) Inventor: Mason E. Eike, Superior, CO (US)

Correspondence Address: MILLEN, WHITE, ZELANO & BRANIGAN, P.C., 2200 CLARENDON BLVD., SUITE 1400, ARLINGTON, VA, 22201, US

(73) Assignee: Dynobolds, L.L.C.

(21) Appl. No.: 10/987,559

(22) Filed: Nov. 12, 2004

Related U.S. Application Data
(60) Provisional application No. 60/524,971, filed on Nov. 25, 2003.

(51) Int. Cl. A62B 1/16

(52) U.S. Cl. 182/90

(57) ABSTRACT

A climbing hold comprises a substrate attachable to a climbing surface. The substrate of the climbing hold comprises a luminescent property associated therewith to facilitate use thereof in generally low and/or specialized lighting conditions.

### CROSS-REFERENCE TO RELATED APPLICATIONS

This application claims priority to U.S. Provisional Application No. 60/524,971, filed Nov. 25, 2003, entitled “Glow in the Dark Artificial Rock Climbing Hold.”

### BACKGROUND OF THE INVENTION

Climbing has become a generally popular form of recreational activity. For example, man-made climbing surfaces can generally be found at health clubs, on cruise ships, in shopping malls and elsewhere.

### SUMMARY OF THE INVENTION

In accordance with one embodiment of the present invention, a climbing hold comprises a substrate attachable to a climbing surface where the substrate has a luminescent property associated therewith.

In accordance with another embodiment of the present invention, a method for producing a climbing hold comprises forming a substrate adapted to be coupled to a surface to facilitate climbing of the surface where the substrate has a luminescent property associated therewith.

### BRIEF DESCRIPTION OF THE DRAWINGS

For a more complete understanding of the present invention and the advantages thereof, reference is now made to the following descriptions taken in connection with the accompanying drawings in which:

FIG. 1 is a diagram illustrating an embodiment of a climbing hold in accordance with the present invention;

FIG. 2 is a diagram illustrating an embodiment of the climbing hold illustrated in FIG. 1 secured to a climbing surface in accordance with the present invention;

FIG. 3 is a diagram illustrating another embodiment of the climbing hold illustrated in FIG. 1 in accordance with the present invention; and

FIG. 4 is a diagram illustrating another embodiment of the climbing hold illustrated in FIG. 1 in accordance with the present invention.

### DETAILED DESCRIPTION OF THE DRAWINGS

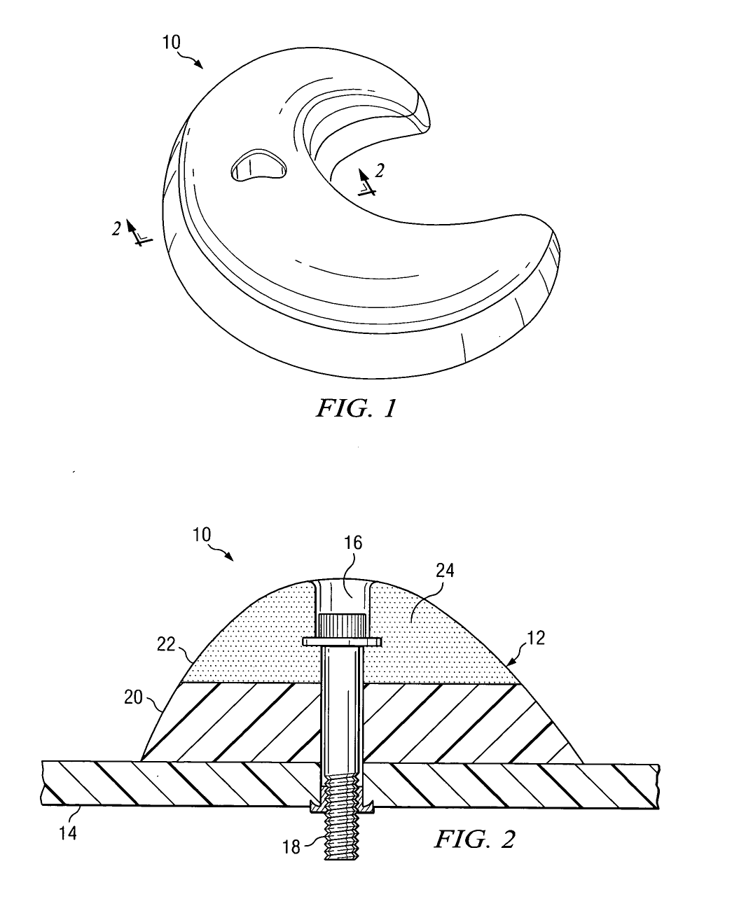

The preferred embodiments of the present invention and the advantages thereof are best understood by referring to FIGS. 1-4 of the drawings, like numerals being used for like and corresponding parts of the various drawings.

FIG. 1 is a diagram illustrating an embodiment of a climbing hold 10 in accordance with the present invention. In the embodiment illustrated in FIG. 1, climbing hold 10 is illustrated as having a generally crescent-shaped geometry. However, it should be understood that climbing hold 10 may be otherwise geometrically configured. Climbing hold 10 is configured to be coupled to an artificial climbing surface to provide a hand and/or foot hold for climbing the artificial surface. In accordance with the present invention, climbing hold 10 is configured having a luminescent property to facilitate use thereof under generally low light conditions and/or other types of specialized lighting conditions.

FIG. 2 is a sectional diagram illustrating an embodiment of climbing hold 10 illustrated in FIG. 1 taken along the line 2-2 of FIG. 1 in accordance with the present invention. In the embodiment illustrated in FIG. 2, climbing hold 10 comprises a substrate 12 couplable to a climbing surface 14. For example, in the embodiment illustrated in FIG. 2, substrate 12 is formed having an opening 16 extending therethrough to facilitate coupling of climbing hold 10 to climbing surface 14. In the embodiment illustrated in FIG. 2, climbing hold 10 is secured to climbing surface 14 via a fastener 18. However, it should be understood that other types of devices and/or methods may be used to secure climbing hold 10 to climbing surface 14. Further, it should be understood that climbing hold 10 may be otherwise configured (e.g., other than opening 16 extending therethrough) to facilitate attachment of climbing hold 10 to climbing surface 14.

In operation, climbing hold 10 is configured having a luminescent property associated therewith to facilitate use of climbing hold 10 in generally low light conditions and/or other types of specialized lighting conditions. For example, in some embodiments of the present invention, substrate 12 is configured using phosphorescent and/or photo-luminescent material that may be charged by exposure to natural and/or artificial light. In other embodiments of the present invention, substrate 12 is configured using a material adapted to be luminescent in response to exposure to ultraviolet light such as UV-A light (e.g., blacklight). Thus, it should be understood that climbing hold 10 may be formed using a variety of different methods to provide a luminescent characteristic for climbing hold 10.

In the embodiment illustrated in FIG. 2, substrate 12 comprises a portion 20 facing and/or otherwise adapted to be disposed toward climbing surface 14 and a portion 22 extending outwardly therefrom. In the embodiment illustrated in FIG. 2, portion 22 is formed having a luminescent property associated therewith. For example, in the embodiment illustrated in FIG. 2, portion 22 comprises a luminescent material 24 disposed therein. In some embodiments of the present invention, luminescent material 24 comprises a phosphorescent and/or photo-luminescent material adapted to be charged in response to exposure to natural and/or artificial light to thereby emit light in generally low light conditions. In other embodiments of the present invention, luminescent material 24 comprises a phosphor and/or fluorescent material that radiates visible light when irradiated with ultraviolet light. For example, in some embodiments of the present invention, portion 22 is formed from a clear polyurethane mixture having luminescent material 24 disposed and/or mixed therein. Portion 20 may comprise any type of metallic or non-metallic material. For example, in some embodiments of the present invention, portion 20 comprises a urethane or polyurethane material which may be cured prior to curing of portion 22 and/or concurrently therewith (e.g., having a separating layer therebetween). However, it should be understood that portions 20 and 22 may be otherwise formed.

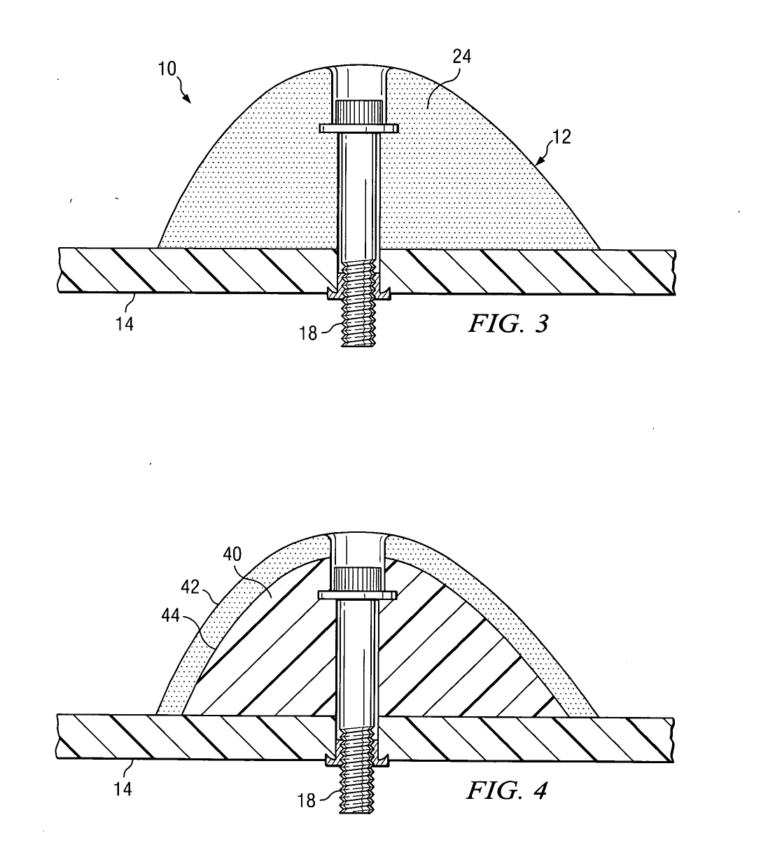

FIG. 3 is a sectional diagram illustrating another embodiment of climbing hold 10 in accordance with the present invention. In the embodiment illustrated in FIG. 3, substrate 12 is formed having luminescent material 24 dispersed throughout thereof. For example, as described above, substrate 12, or a portion thereof, may be formed by mixing and/or otherwise dispersing luminescent material 24 within substrate 12 (e.g., a clear polyurethane material).

FIG. 4 is a sectional diagram illustrating another embodiment of climbing hold 10 in accordance with the present invention. In the embodiment illustrated in FIG. 4, climbing hold 10 comprises a substrate 40 having a luminescent material 42 applied and/or otherwise deposited thereto. As described above, in some embodiments of the present invention, luminescent material 42 comprises a phosphorescent and/or photo-luminescent material adapted to be charged in response to exposure to natural and/or artificial light to thereby emit light in generally low light conditions. In other embodiments of the present invention, luminescent material 42 comprises a phosphor and/or fluorescent material that radiates visible light when irradiated with ultraviolet light. In the embodiment illustrated in FIG. 4, luminescent material 42 comprises a coating applied and/or otherwise deposited onto an outwardly exposed or directed surface 44 of substrate 40. Substrate 40 may comprise any type of metallic or non-metallic material.

1. A climbing hold, comprising:
a substrate attachable to a climbing surface, the substrate having a luminescent property associated therewith.

2. The adapter of claim 1, wherein the luminescent property comprises a luminescent coating applied to the substrate.

3. The adapter of claim 1, wherein the luminescent property comprises a luminescent material disposed within the substrate.

4. The adapter of claim 1, wherein the substrate comprises a first portion and a second portion, the first portion adapted to be disposed toward the climbing surface, the second portion having the luminescent property associated therewith.

5. The adapter of claim 1, wherein the luminescent property comprises a phosphorescent material adapted to be charged in response to being exposed to light.

6. The adapter of claim 1, wherein the substrate is adapted to be luminescent in response to being exposed to ultraviolet light.

7. The adapter of claim 1, wherein the substrate comprises at least one opening through which the climbing hold is secured to the climbing surface.

8. A method for producing a climbing hold, comprising:
forming a substrate adapted to be coupled to a surface to facilitate climbing of the surface, the substrate having a luminescent property associated therewith.

9. The method of claim 8, wherein forming the substrate comprises applying a luminescent material onto the substrate.

10. The method of claim 8, wherein forming the substrate comprises molding the substrate having a luminescent material disposed therein.

11. The method of claim 8, wherein forming the substrate comprises forming the substrate having an opening through which the climbing hold is couplable to the surface.

12. The method of claim 8, wherein forming the substrate comprises forming the substrate using a phosphorescent material adapted to be charged in response to exposure to light.

13. The method of claim 8, wherein forming the substrate comprises forming the substrate of a material adapted to be luminescent in response to being exposed to ultraviolet light.

14. A climbing apparatus, comprising:
a climbing surface having at least one climbing hold disposed thereon, the climbing hold having a luminescent property associated therewith.

15. The apparatus of claim 14, wherein the climbing hold is adapted to be luminescent in response to being charged by exposure to light.

16. The apparatus of claim 14, wherein the climbing hold is adapted to be luminescent in response to being exposed to ultraviolet light.

17. The apparatus of claim 14, wherein the climbing hold is couplable to the climbing surface via an opening formed therein.
